(19) United States
(12) Patent Application Publication
(10) Pub. No.: US 2011/0114875 A1
(43) Pub. Date: May 19, 2011

(54) ELECTROCHEMICALLY ACTIVE MATERIALS AND PRECURSORS THERETO

(76) Inventor: Guiqing Huang, Newton, MA (US)

(21) Appl. No.: 12/946,905

(22) Filed: Nov. 16, 2010

Related U.S. Application Data
(60) Provisional application No. 61/281,262, filed on Nov. 16, 2009.

(51) Int. Cl. H01M 4/90; B82Y 30/00

(52) U.S. Cl. 252/182.1; 977/775

(57) ABSTRACT

The invention provides unique methods and compositions useful for preparing high-quality, nano-scale powdery precursor materials that are efficiently converted to electrochemically active materials, for example those useful in rechargeable lithium-ion batteries as electrode materials and various applications.

### PRIORITY CLAIMS AND RELATED APPLICATIONS

This application claims the benefit of U.S. Provisional Application No. 61/281,262, filed Nov. 16, 2009, the entire content of which is expressly incorporated herein by reference for all purposes.

### FIELD OF THE INVENTION

The invention generally relates to electrochemically active materials and precursors thereto. More particularly, the invention relates to unique methods and compositions useful for preparing high-quality, nano-scale powdery precursor materials that are efficiently converted to electrochemically active materials, for example those useful in rechargeable lithium-ion batteries as electrode materials and various applications.

### BACKGROUND OF THE INVENTION

Recent years have seen a continued increase in the demand for secondary batteries as energy sources for portable electronic products and mobile equipment. Among these secondary batteries, lithium secondary batteries having high energy density and voltage, long life span and low self-discharge are commercially available and widely used. At the same time, the demand for large-scale dynamical lithium-ion power supply also develops rapidly.

Cobalt-based lithium ion batteries encounter thermal runaway problems, higher toxicity and other environmental limitations, which have prevented Cobalt-based lithium ion batteries them from applications that need large battery systems, for example, in electric vehicles or automobiles and large-scale energy storage systems.

LiNiO₂ has lower cost and higher capacity, but it is difficult to manufacture and has relatively unsatisfactory thermal stability and safety profiles. Orthogonal olivine LiFePO₄ is a new lithium-ion battery cathode material that possesses high capacity and steady voltage of charge and discharge, as well as low price, good thermal stability, and environmental profile.

Lithium ion batteries are also relatively light and small in size and have high energy capacity. Lithium ion batteries have been used as the power supply mobile phones and laptop computers and have increasing been considered as the power supply for electric cars, hybrid cars, electric tools, and the like, where high-speed charging and discharging properties are desired.

One issue with such batteries based on lithium ion has been the need to improve Lithium ion diffusion rate in the solid phases. Reducing LiFePO₄ particle size and reduced dimension of nano-materials can reduce the path length over which the electron and Li ion have to travel so as to facilitate an efficient Lithium ion and electron transport and to make possible rapid charging and discharging batteries. The ability to charge and discharge batteries in a matter of seconds rather than hours may allow new technological applications and induce lifestyle changes (Kang, et al., Nature 458 (2009)190-193).

Therefore, there is an urgent need for novel technologies that overcome the shortcomings in active materials that have led to high cost, low capacity, and low capacity retention at high discharge rate in rechargeable lithium-ion batteries.

### SUMMARY OF THE INVENTION

The invention is based in part on the unexpected discovery that electrochemically active materials with enhanced electrochemical properties can be prepared efficiently and at relatively low cost from precursors that are prepared according to methods disclosed herein. For example, powdery precursor materials with nano-scale primary particle sizes can be obtained according to the present invention. Such fine particle (e.g., nano-size) precursors enable the preparation of electrochemically active materials with excellent high-drain properties, for example. The methods of the invention are generally efficient and cost effective, as well as stable and scalable, and are uniquely developed to achieve active electrochemical materials with high capacity, good discharge profile, and good voltage plateau retention at high discharge rate, as well as long cycle life.

In one aspect, the invention generally relates to a method for preparing a nano-scale powdery precursor material LiₐM_{b}XO₄ that is useful as an electrochemically active material. The method includes: mixing thoroughly a lithium source material, a metal source material for M, a source material for XO₄, in pre-determined molar ratios, in the present or the absent of a carbon source material, and an organic solvent to obtain an amorphous mixture; heating the amorphous mixture of source materials to a temperature between about 50° C. to less than or equal to the solvent boiling point at atmospheric pressure for about 0.5 to about 2 hours to obtain a reaction mixture; stirring the reaction mixture at room temperature for about 5 to about 20 hours to obtain a precursor material; separating the powdery precursor from the solvent. The method further includes drying by heating the powdery precursor at a temperature between about 50° C. to about 70° C. for about 2 to about 10 hours to obtaining a first nano-scale powdery precursor material; heating the first nano-scale powdery precursor material at about 300° C. to about 400° C. for about 1 to about 10 hours to obtain a second nano-scale powdery precursor material; and heating the second nano-scale powdery precursor material first at about 300° C. to about 400° C. for about 1 to about 5 hours then at about 500° C. to about 800° C. for about 3 to about 10 hours, thereby obtaining a nano-scale powdery electrochemically active material. Here, M comprises at least one metal capable of undergoing oxidation to a higher valence state; wherein X is selected from the group consisting of P, Sb, V, S, Si, Al, Ge, As, and a mixture of two of more thereof; a and b are positive integer or fraction of an integer and ranges from about 0.001 to about 3.

In another aspect, the invention generally relates to a nano-scale powdery precursor material useful as an electrochemically active material, which is prepared by the following process: mixing thoroughly a lithium source material, a metal source material for M, a source material for XO₄, in pre-determined molar ratios, in the present or the absent of a carbon source material, in pre-determined molar ratios in an organic solvent to obtain an amorphous mixture; heating the amorphous mixture of source materials to a temperature between about 50° C. to less than or equal to the solvent boiling point at atmospheric pressure for about 0.5 to about 2 hours to obtain a reaction mixture; stirring the reaction mixture at room temperature for about 5 to about 20 hours to obtain a precursor material; separating the powdery precursor from the solvent; and drying by heating the powdery precursor at a temperature between about 50° C. to about 70° C. for about 2 to about 10 hours to obtaining a nano-scale powdery precursor material. Here, M comprises at least one metal capable of undergoing oxidation to a higher valence state. X is selected from the group consisting of P, Sb, V, S, Si, Al, Ge, As, and a mixture of two of more thereof. The nano-scale powdery precursor material has the formula of LiₐM_{b}XO₄, wherein a and b are positive integer or fraction of an integer and ranges from about 0.001 to about 3.

In yet another aspect, the invention generally relates to a precursor to a lithium iron phosphate material cathode active material, which is prepared by the following process: mixing thoroughly a lithium source material, an iron phosphate source material, and a carbon source material in pre-determined molar ratios in an organic solvent to obtain a mixture of source materials; heating the amorphous mixture of source materials to a temperature between about 50° C. to less than or equal to the solvent boiling point at atmospheric pressure for about 0.5 to about 2 hours to obtain a reaction mixture; stirring the reaction mixture at room temperature for about 5 to about 20 hours to obtain a precursor material; separating the powdery precursor from the solvent; and drying by heating the powdery precursor at a temperature between about 50° C. to about 70° C. for about 2 to about 10 hours to obtaining a nano-scale powdery precursor material.

### BRIEF DESCRIPTION OF THE DRAWINGS

FIG. 1 shows an exemplary scanning electron microscopy image of LiFePO4(LFP) first precursor prepared according to the present invention, showing the particle size of about 25-80 nm.

FIG. 2 shows an exemplary scanning electron microscopy image of LFP second precursor prepared according to the present invention, showing the particle size of about 25-80 nm.

FIG. 3 shows an exemplary scanning electron microscopy image of active material LiFePO₄ prepared according to the present invention, showing the particle size of about 25-80 nm.

FIG. 4 shows an exemplary charge and discharge at various rates for active material LiFePO₄ prepared according to the present invention. The voltage window is approximately 2.0-4.2 V. The electrode formulation is active material (85 wt %), carbon (7 wt %) and binder (8 wt %).

FIG. 5 shows an exemplary charge and discharge capacity retention and cycling efficiency data for active material LiFePO₄ prepared according to the present invention. The voltage window is approximately 2.0-4.2 V or 2.5-4.2 V. The electrode formulation is active material (85 wt %), carbon (7 wt %) and binder (8 wt %). The whole test took about 3 mouths at room temperature. Temperature derivation could be up to about 10° C. daily.

FIG. 6 shows exemplary powder X-ray diffraction patterns (using Cu Ka radiation) for active material LiFePO₄ synthesized in Example 3 according the present invention.

FIG. 7 shows exemplary powder X-ray diffraction patterns (using Cu Ka radiation) for active material Li₃V₂(PO₄)₃ synthesized in Example 4 according the present invention.

FIG. 8 shows charge and discharge at various rates for active material Li₃V₂(PO₄)₃ prepared in Example 4 according to the present invention. The voltage window is approximately 3.0-4.5 V. The electrode formulation is active material (78 wt %), carbon (10 wt %) and binder (12 wt %).

FIG. 9 shows powder X-ray diffraction patterns (using Cu Ka radiation) for LiFePO₄ second precursor synthesized in Example 5 according the present invention.

### DETAILED DESCRIPTION OF THE INVENTION

The invention is based in part on the unexpected discovery that substantially improved electrochemically active materials can be prepared efficiently and at relatively low cost from precursors that are prepared according to methods disclosed herein.

Nano-scale powdery precursor materials can be obtained according to the present invention. Nano-size particulate precursor materials enable the preparation of electrochemically active materials with excellent high-drain properties, for example. The methods disclosed herein are efficient and generally cost effective, as well as stable and scalable, and are uniquely developed to achieve active electrochemical materials with high capacity, good discharge profile, and good voltage plateau retention at high discharge rate, as well as long cycle life.

Small particle size is the most important factor for LiFePO₄-based cathode materials to dedicate high rate capacity and high rate energy density. Gaberscek et al., Electrochemistry Comm. 9 (2007)2778-2783, showed for the first time that in LiFePO₄-based cathode materials the electrode resistance depends solely on the mean particle size. Thus, in order to achieve a high rate capability of LiFePO4 electrodes, more emphasis should be placed on the particle size minimization. Myeong-Hee Lee, et al. Chem. Comm. 46 (2010)6795-6797, showed that the nano-dimension of the primary particles of LiFePO₄ is the most important contribution to LiFePO₄ high power discharge performances. Such performances includes discharge with small voltage plateau change at high C rate, indicating higher energy density can be obtained with the same capacity materials with higher voltage plateau. The C rate is often used to describe battery loads or battery charging. It is the theoretical amount of current a battery delivers when discharged in one hour to the point of 100% depth of discharge. 1 C is the capacity rating (Amp-hour) of a battery.

In one aspect, the invention generally relates to a method for preparing a nano-scale powdery precursor material LiₐM_{b}XO₄ that is useful as an electrochemically active material. The method includes: mixing thoroughly a lithium source material, a metal source material for M, a source material for XO₄, in pre-determined molar ratios, in the present or the absent of a carbon source material, and an organic solvent to obtain an amorphous mixture; heating the amorphous mixture of source materials to a temperature between about 50° C. to less than or equal to the solvent boiling point at atmospheric pressure for about 0.5 to about 2 hours to obtain a reaction mixture; stirring the reaction mixture at room temperature for about 5 to about 20 hours to obtain a precursor material; separating the powdery precursor from the solvent. The method further includes drying by heating the powdery precursor at a temperature between about 50° C. to about 70° C. for about 2 to about 10 hours to obtaining a first nano-scale powdery precursor material; heating the first nano-scale powdery precursor material in an inert atmosphere at about 300° C. to about 400° C. for about 1 to about 10 hours to obtain a second nano-scale powdery precursor material; and heating the second nano-scale powdery precursor material in an inert atmosphere first at about 300° C. to about 400° C. for about 1 to about 10 hours then at about 500° C. to about 800° C. for about 3 to about 10 hours, thereby obtaining a nano-scale powdery electrochemically active material. Here, M comprises at least one metal capable of undergoing oxidation to a higher valence state; wherein X is selected from the group consisting of P, Sb, V, S, Si, Al, Ge, As, and a mixture of two of more thereof; a and b are positive integer or fraction of an integer and ranges from about 0.001 to about 3.

The lithium source may be any lithium source useful and applicable to the present invention. In certain embodiments, the lithium source material is selected from Li-COOH (Lithium formate), Li₂O, lithium oxalate, LiOH, CHCOOLi, lithium phosphate, LiF, LiI, LiH₂PO₄, or a mixture of two or more thereof.

The carbon source may be any carbon source useful and applicable to the present invention. In certain embodiments, the carbon source is selected from an inorganic carbon-containing material, an organic bon-containing material. an polymeric carbon-containing material, a natural product carbon source, or a mixture of two or more thereof.

The organic solvent may be any organic solvent useful and applicable to the present invention. In some embodiments, the organic solvent is selected from ethanol, acetone, ethylene glycol, isopropanol, DMF, or a mixture of two or more thereof.

M is one or more of a metal, for example, selected from Mg, Al, Si, Ca, Sc, Ti, V, Cr, Mn, Fe, Co, Ni, Cu, Zn, Ga, Ge, Sr, Zr, Nb, Mo, Ta, or W.

In some embodiments, Fe is obtained from a source material selected from FeO, Fe₂O₃, Fe₃O₄, ferric hydroxide, ferrous hydroxide, FePO₄, Fe₂(PO₄)₃, ferrous ammonium phosphate, ferric pyrophosphate, ferric nitrate, ferrous nitrate, ferrous sulfate, ferric sulfate, ferric chloride, ferrous chloride, iron carbonate, ferrous carbonate, ferrous oxalate, or a mixture of two or more thereof.

In certain embodiments, X is P and the X source material is a phosphate source material, for example, iron phosphate, H₃PO₄, P₂O₅, NH₄H₂PO₄, (NH₄)₂HPO₄, NH₄FePO₄, (NH₄)₃PO₄, Li₃PO₄, LiH₂PO₄, FePO₄, Fe₃(PO₄)₂, or a mixture of two or more thereof.

In certain embodiments, M is V and the M source material is a vanadium source material, for example, V₂O₅, V₂O₃, NH₄VO₃, or a mixture of two or more thereof.

In some embodiments, the carbon source is selected from an inorganic carbon-containing material, an organic carbon-containing material, a polymeric carbon-containing material, or a natural product carbon source, or a mixture of two or more thereof.

For example, in certain embodiments, the carbon source may be selected from Saccharose, fructose, propanedioic acid, adipic acid, acrylic acid, salicylic acid, lauric acid, ascorbic acid, Oleic acid, isocaproatic acid, citric acid, or a mixture or two or more thereof.

In some other embodiments, the carbon source may be a polymeric carbon-containing material selected from polyethylene glycol (PEG), polyvinyl alcohol (PVA), polyvinyl butyral (PVB), Polypropylene, polyethylene, poly-pyrrolidone (PUP), polyacrylic acid (PAA), polypyrrole (PPY), or a mixture of two or more thereof.

In certain embodiments, the carbon source may be soybean oil, fiber, chitosan, starch, kerosene, or a mixture of two or more thereof.

In some other embodiments, the carbon source is an inorganic carbon-containing carbon black, Super P carbon, nano-carbon, carbon nanotube, graphite oxide composites and nano-composites, graphene, graphene based composites and nano-composites, or a mixture thereof.

The molar ratio of the lithium source material:the metal source material:the phosphate source material may be about 0.9-1.2:about 0.6-1.2:about 0.9-1.2, for example. In some embodiments, the molar ratio of the lithium source material:the metal source material:the phosphate source material may be about 1.0-1.2:about 0.8-1.2:about 1.0-1.2. In some embodiments, the molar ratio of the lithium source material:the metal source material:the phosphate source material may be about 0.9-1.1:about 0.8-1.0:about 0.9-1.0.

The weight ratio of the carbon source material:the metal source material may be anything appropriate to a particular application, for example, such ratio may be from 0 to about 45 g per mole, from about 0 to about 30 g per mole, from about 5 to about 25 g per mole.

The first and/or second nano-scale powdery precursor materials may have particle sizes from about 25 nm to about 500 nm, from about 50 nm to about 400 nm, from about 50 nm to about 200 nm, from about 100 nm to about 200 nm, for example.

Depending on the particular application, some of the steps of the methods of the invention may be carried out in an inert atmosphere, such as in a flow or pressure of an inert gas (e.g., Argon or Nitrogen).

The particular temperatures and lengths of the above heating or stirring steps, such as heating the mixture of source materials, may be adjusted dependent on the source materials used, their quality and quantity, reaction vessels use, etc. For instance, the mixture of source materials may be heated to a temperature between about 50° C. above room temperature to less than or equal to the solvent boiling point at atmospheric pressure for about 0.5 to about 5 hours.

Similarly, stirring the reaction mixture may be done at room temperature or up to 50° C. higher for about 5 to about 30 hours to obtain a precursor material.

As disclosed herein, the method of the invention further includes drying the powdery precursor material by heating at a temperature between about 50° C. to about 70° C. for about 2 to about 50 hours (e.g., 60° C. to for 10 hours) to obtain a first nano-scale powdery precursor material. The first nano-scale powdery precursor material is then heated, for example, in an inert atmosphere at about 300° C. to about 400° C. (e.g., 350° C.) for about 1 to about 10 hours (e.g., for 3 hours) to obtain a second nano-scale powdery precursor material. The second nano-scale powdery precursor material is then heated, for example, in an inert atmosphere first at about 300° C. to about 400° C. (e.g., 350° C.) for about 1 to about 10 hours (e.g., for 2 hours) then at about 500° C. to about 800° C. (e.g., 600° C.) for about 3 to about 20 hours to produce a nano-scale powdery electrochemically active material.

In another aspect, the invention generally relates to a nano-scale powdery precursor material useful as an electrochemically active material, which is prepared by the following process: mixing thoroughly a lithium source material, a metal source material for M, a source material for XO₄, in pre-determined molar ratios, in the present or the absent of a carbon source material, in pre-determined molar ratios in an organic solvent to obtain an amorphous mixture; heating the amorphous mixture of source materials to a temperature between about 50° C. to less than or equal to the solvent boiling point at atmospheric pressure for about 0.5 to about 2 hours to obtain a reaction mixture; stirring the reaction mixture at room temperature for about 5 to about 20 hours to obtain a precursor material; separating the powdery precursor from the solvent; and drying by heating the powdery precursor at a temperature between about 50° C. to about 70° C. for about 2 to about 10 hours to obtaining a nano-scale powdery precursor material. Here, M comprises at least one metal capable of undergoing oxidation to a higher valence state. X is selected from the group consisting of P, Sb, V, S, Si, Al, Ge, As, and a mixture of two of more thereof. The nano-scale powdery precursor material has the formula of LiₐM_{b}XO₄, wherein a and b are positive integer or fraction of an integer and ranges from about 0.001 to about 3.

In yet another aspect, the invention generally relates to a precursor to a lithium iron phosphate material cathode active material, which is prepared by the following process: mixing thoroughly a lithium source material, an iron phosphate source material, and a carbon source material in pre-determined molar ratios in an organic solvent to obtain a mixture of source materials; heating the amorphous mixture of source materials to a temperature between about 50° C. to less than or equal to the solvent boiling point at atmospheric pressure for about 0.5 to about 2 hours to obtain a reaction mixture; stirring the reaction mixture at room temperature for about 5 to about 20 hours to obtain a precursor material; separating the powdery precursor from the solvent; and drying by heating the powdery precursor at a temperature between about 50° C. to about 70° C. for about 2 to about 10 hours to obtaining a nano-scale powdery precursor material.

The present invention provides methods for producing precursors and electrochemically active materials. The invention therefore provides effective improvements of electrochemical properties and methods of preparation that are efficient and cost-effective. Laboratory cells constructed with such cathode active material (e.g., LiFePO₄) exhibit greatly improved capacity and voltage plateau retention at high charge and discharge rates.

For example, over a voltage range of 2.0V-4.2V for discharge, the discharge capacity measured at a 5 C rate compared to the capacity measured at a low rate of C/5 or less (at the C/5 rate the discharge capacity will be 157 mAh/g or greater), the capacity retention is about 85% or greater, in some cases about 90% or greater. At a 10 C rate, the capacity retention can be about 80% or greater, in some cases about 85% or greater. At a 20 C rate, the capacity retention can be about 70% or greater, in some cases about 80% or greater. At a 30 C rate, the capacity retention can be about 65% or greater, in some cases about 70% or greater. At a 40 C rate, the capacity retention can be about 60% or greater, in some cases about 65% or greater. At a 50 C rate, the capacity retention can be about 55% or greater, in some cases about 60% or greater. At a 60 C rate, the capacity retention can be about 50% or greater, in some cases about 55% or greater.

It also results in high initial discharge capacity (for LFP up to 160 mAh/g), and allows for very low cycling capacity loss and retains extremely high discharge capacity at high discharge rate.

Therefore, the present invention provides a unique preparative method for making nano-scale lithium phosphate precursors. With nano-scale precursors one can more readily prepare nano-scale electrochemically active materials, which exhibit improved electronic conductivity, increase electromechanical stability, etc. Such active materials are useful for producing devices such as high energy and high power storage batteries.

### EXAMPLES

### Example 1

Lithium iron phosphate precursor LiFePO₄ was prepared using source materials as follows:

| Starting materials | Amount |
|---|---|
| Lithium formate | 4.50 g |
| Iron phosphate | 12 g |
| Cellulose acetate | 1.3 g |
| CTAB | 0.1 g |

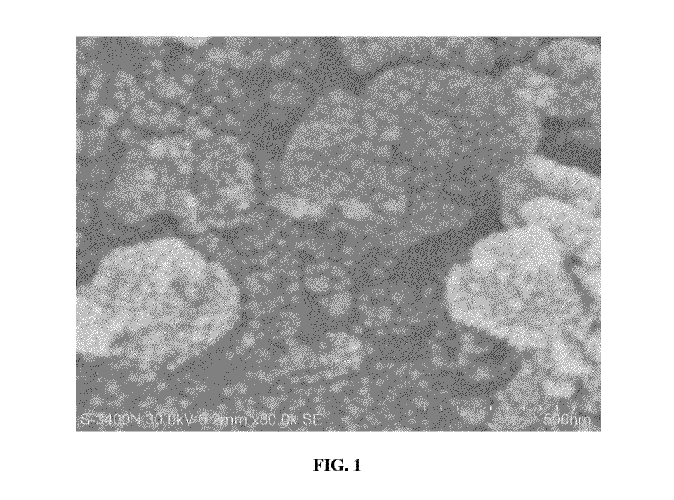

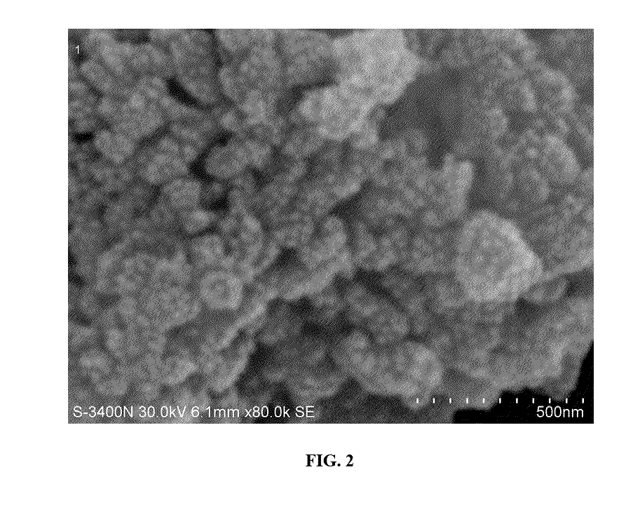

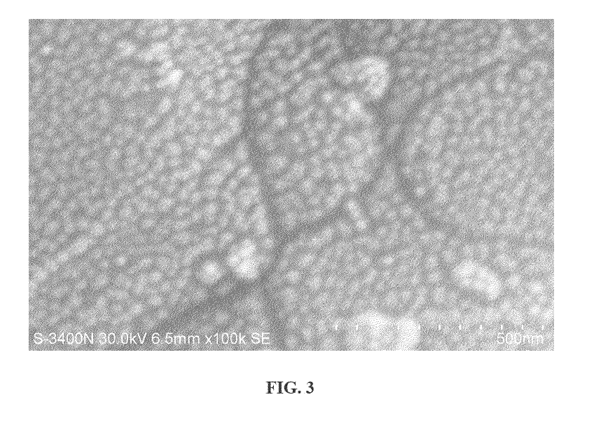

Isopropyl alcohol was used as solvent with extended mixing and raising the temperature to 60° C. to allow the mixture of the above starting components to undergo a reaction for 1 hour. Then, heating is stopped and stirring was maintained continually for another 15 hours. The precursor so obtained was thoroughly dried by heating the powdery precursor at a temperature between about 50° C. to about 70° C. for about 2 hours to obtain a first nano-scale powdery precursor material. Heating the first nano-scale powdery precursor material in an inert atmosphere at about 300° C. to about 400° C. for about 1 to about 5 hours obtained a second nano-scale powdery precursor material. And heating the second nano-scale powdery precursor material in a tube furnace under flowing argon gas first at about 300° C. to about 400° C. for about 1 to about 5 hours then at 600° C. for about 6 hours, a nano-scale powdery electrochemically active material was obtained. After heat treatment, the carbon content was analyzed by the combustion method and found to be about 3 weight percent. For powders prepared by this procedure, electron microscopy imaging, such as in FIGS. 1, 2, and 3 showed that the observed average particle diameters for the precursor material and fired powder were close to each other, in the range of 25-801 nm.

The fired powder was formulated into an electrode having the following composition:

| | |
|---|---|
| Nano-scale lithium iron phosphate active | 85% |
| material LiFePO₄ | |
| conductive black carbon | 7% |
| polyvinylidene fluoride (PVDF) binder | 8% |

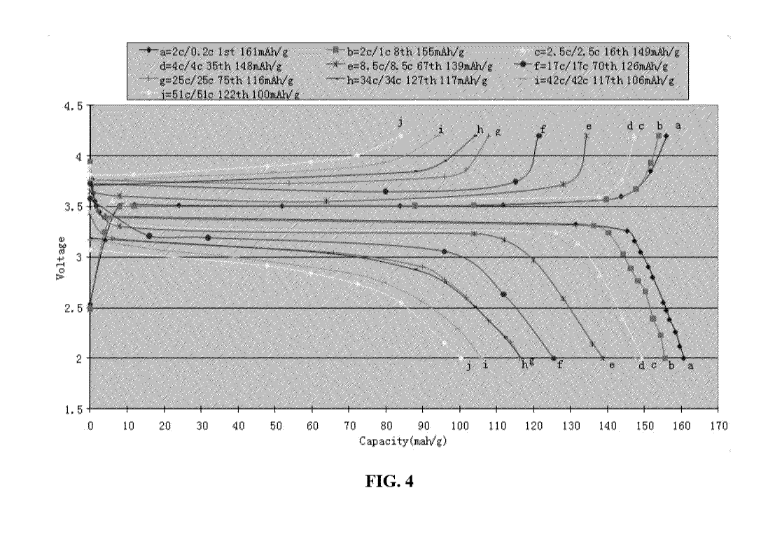

N-Methyl pyrrolidone (NMP) was used as solvent to create a free homogenous flowing slurry. A uniform layer is then casted onto aluminum foil. The coating was dried in vacuum at 100-110° C. The electrode coatings were assembled into lithium half-cells using coin cell hardware, using lithium foil as the negative electrode, LiPF₆ as electrolyte. FIG. 4 shows the specific capacity of the nano-scale lithium iron phosphate as measured from a coin cell. The ability of the nano-scale material to deliver high capacities at high charge or discharge rates is remarkable. Under the discharge rate of 0.2 C, 1 C, 2.5 C, 4 C, 8.5 C, 17 C, 25 C, 34 C, 42 C, and 51 C, the capacity is 161, 155, 149, 148, 139, 126, 116, 117, 105, and 100 mAh/g, respectively. The discharge capacity retention here is used to describe the percentage of the capacity measured at a particular C-rate, over the voltage range 2.0-4.2V, compared to the capacity observed at C/5 rate over the same voltage range, as shown in FIG. 4. At 1 C rate, the capacity retention was 96.7%; at 2.5 C, 4 C, 8.5 C, 17 C, 25 C, 34 C, 42 C, and 51 C, the retention was 92.5%, 91.9%, 86.3%, 78.3%, 72.0%, 72.7%, 65.2%, and 62.1%, respectively. The high-power charge/discharge has small change of voltage plateau (FIG. 4), indicating higher energy density can be obtained with such materials.

### Example 2

A nano-scale LiFePO₄ precursor was synthesized and tested following the procedures as described in Example 1, except that a larger batch size was made and different source materials were used. The composition was made using starting materials as follows:

| Starting materials | Amount |
|---|---|
| Lithium acetate | 4.28 kg |
| Iron phosphate | 12 kg |
| Cellulose acetate | 1.3 kg |
| CTAB | 0.1 kg |
| (Hexadecyltrimethylammonium | |
| bromide) | |

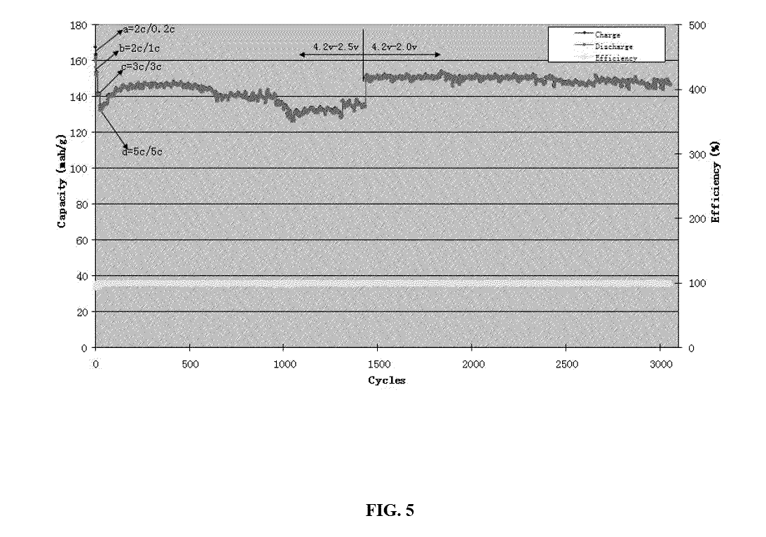

A steel container was used to conduct the reaction. Ethanol was used as solvent with extended mixing for one hour and the temperature was raised to 60° C. to allow the starting components to undergo a reaction for 2 hour. Then, heating was stopped and stirring was continued for another 20 hours. The precursor material so obtained was thoroughly dried and then heat treated in a tube furnace under flowing argon gas, first at 350° C. for 3 hours and then at 600° C. for 6 hours. Combustion analysis showed that it had a residual carbon concentration of about 3 wt %. FIG. 5 shows test results from electrodes and lithium half-cells constructed as in Example 1. At higher C-rates, outstanding capacity retention after more than 3000 cycles was observed. At a 5 C rate, the capacity retention was about 90% compared to the capacity observed at C/5 rate over the same voltage range. After more than 3000 cycles at 5 C rate charge and discharge, no significant capacity loss was observed.

### Example 3

A nano-scale LFP precursor was synthesized and tested following the procedures as described in Example 1, except that different starting materials were used. The composition was made using the following proportions of starting materials:

| Starting materials | Amount |
|---|---|
| FeC₂O₄•2H₂O | 11.9 g |
| LiH₂PO₄ | 6.86 g |

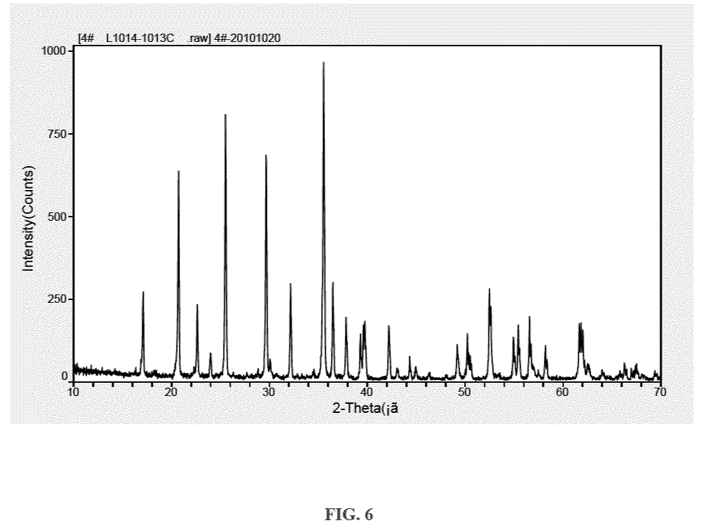

Ethanol was used as solvent with extended mixing for half hour, and the temperature was raised to 60° C. to allow the starting components to undergo a reaction for 1 hour. Heating was then stopped and stirring was continued for another 15 hours. The LFP precursor material obtained was thoroughly dried and then heat treated in a tube furnace under flowing argon gas, first at 350° C. for 3 hours and then at 600° C. for 6 hours to generate final active material. FIG. 6 shows powder X-ray diffraction patterns (using Cu Ka radiation) for LFP active material.

### Example 4

Lithium vanadium phosphate precursor Li₃V₂(PO₄)₃ (LVP) was prepared using source materials as follows:

| Starting materials | Amount |
|---|---|
| Li₂CO₃ | 2.52 g |
| V₂O₅ | 2.00 g |
| NH₄H₂PO₄ | 3.80 g |
| Acrylic acid | 0.5 g |

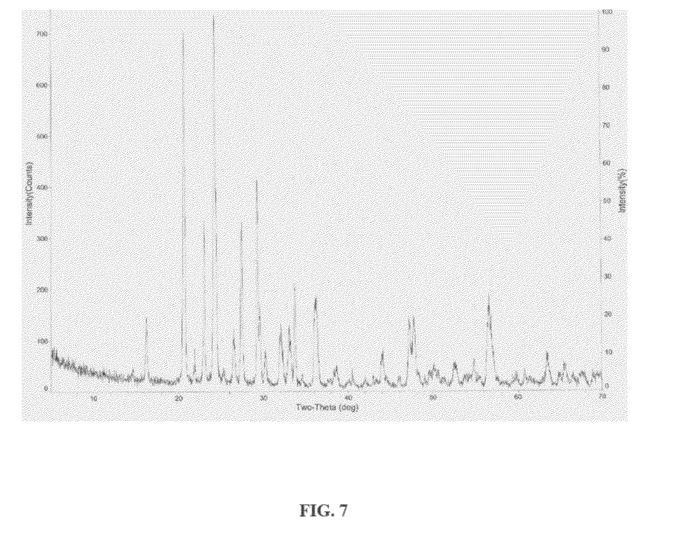

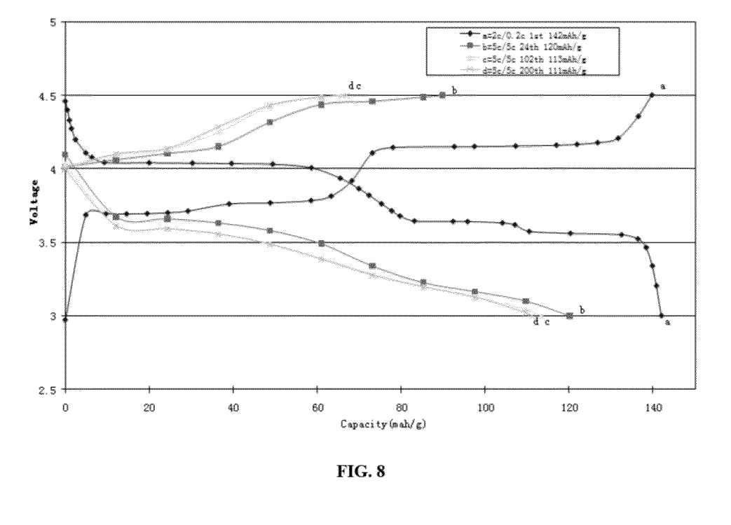

Ethanol was used as solvent with extended mixing for half hour. The temperature was raised to 60° C. to allow the starting components to undergo a reaction for 1 hour. Heating was stopped and stirring was continued for another 15 hours to obtain the LVP precursor. The LVP precursor was thoroughly dried and then heat treated in a tube furnace under flowing argon gas, first at 350° C. for 3 hours and then at 600° C. for 6 hours to finally generate LVP active material. Combustion analysis showed that it had a residual carbon concentration of about 3 wt %. FIG. 7 shows powder X-ray diffraction patterns (using Cu Ka radiation) for LVP active material. FIG. 8 shows test charge and discharge results from electrodes and lithium half-cells constructed as in Example 1, except that it was formulated into an electrode having the following composition:

| | |
|---|---|
| Nano-scale lithium vanadium phosphate | 78% |
| Li₃V₂(PO₄)₃active material | |
| conductive black carbon | 10% |
| polyvinylideue fluoride (PVDF) binder | 12% |

FIG. 8 shows that, for 2 C/0.2 C charge/discharge rate, the discharge capacity was 142 mAh/g. For 5 C/5 C charge/discharge rate, after 200 cycles the capacity retention had no significant change.

### Example 5

Lithium iron phosphate precursor LFP was prepared using source materials as follows:

| Starting materials | Amount |
|---|---|
| LiOH•H₂O | 2.75 g |
| NH₄FePO₄•H₂O | 12 g |
| CTAB | 0.1 g |

Isopropyl alcohol was used as solvent with extended mixing for half hour, and the temperature was raised to 60° C. to allow the starting

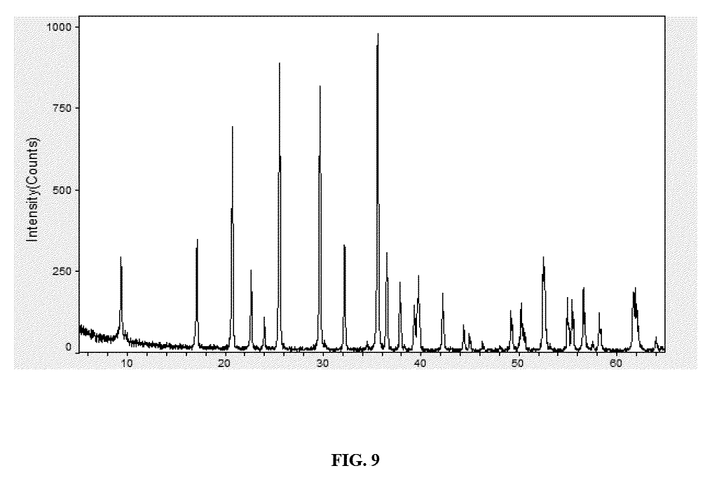

components to undergo a reaction for 1 hour. Heating was then stopped and stirring was continued for another 15 hours. The first LFP precursor material obtained was thoroughly dried and then heat treated in a tube furnace under flowing argon gas at 400° C. for 6 hours to generate second LFP precursor. FIG. 9 shows powder X-ray diffraction patterns (using Cu Ka radiation) for the second LFP precursor.

### INCORPORATION BY REFERENCE

References and citations to other documents, such as patents, patent applications, patent publications, journals, books, papers, web contents, have been made in this disclosure. All such documents are hereby incorporated herein by reference in their entirety for all purposes.

### EQUIVALENTS

The representative examples which follow are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. The following examples contain important additional information, exemplification and guidance which can be adapted to the practice of this invention in its various embodiments and equivalents thereof.

What is claimed is:

1. A method for preparing a nano-scale powdery precursor material LiₐM_{b}XO₄ useful as an electrochemically active material, comprising:
mixing thoroughly a lithium source material, a metal source material for M, a source material for XO₄, in pre-determined molar ratios, in the present or the absent of a carbon source material, and an organic solvent to obtain an amorphous mixture;
heating the amorphous mixture of source materials to a temperature between about 50° C. to less than or equal to the solvent boiling point at atmospheric pressure for about 0.5 to about 2 hours to obtain a reaction mixture;
stirring the reaction mixture at room temperature for about 5 to about 20 hours to obtain a precursor material;
separating the powdery precursor from the solvent;
drying by heating the powdery precursor at a temperature between about 50° C. to about 70° C. for about 2 to about 10 hours to obtaining a first nano-scale powdery precursor material;
heating the first nano-scale powdery precursor material in an inert atmosphere at about 300° C. to about 400° C. for about 1 to about 10 hours to obtain a second nano-scale powdery precursor material; and
heating the second nano-scale powdery precursor material in an inert atmosphere first at about 300° C. to about 400° C. for about 1 to about 5 hours then at about 500° C. to about 800° C. for about 3 to about 10 hours, thereby obtaining a nano-scale powdery electrochemically active material,
wherein M comprises at least one metal capable of undergoing oxidation to a higher valence state; wherein X is selected from the group consisting of P, Sb, V. S. Si, Al, Ge, As, and a mixture of two of more thereof; a and b are positive integer or fraction of an integer and ranges from about 0.001 to about 3.

2. The method of claim 1, wherein the lithium source material is selected from Li-COOH, Lithium formate), Li₂O, lithium oxalate, LiOH, CHCOOLi, lithium phosphate, LiF, LiI, LiH₂PO₄, or a mixture of two or more thereof.

3. The method of claim 1, wherein the carbon source is selected from an inorganic carbon-containing material, an organic carbon-containing material, an polymeric carbon-containing material, a natural product carbon source, or a mixture of two or more thereof.

4. The method of claim 1, wherein the organic solvent is selected from ethanol, acetone, ethylene glycol, isopropanol, DMF, or a mixture of two or more thereof.

5. The method of claim 1, wherein M is one or more of a metal selected from Mg, Al, Si, Ca, Sc, Ti, V, Cr, Mn, Fe, Co, Ni, Cu, Zn, Ga, Ge, Sr, Zr, Nb, Mo, Ta, and W.

6. The method of claim 5, wherein Fe is from a source material selected from FeO, Fe₂O₃, Fe₃O₄, ferric hydroxide, ferrous hydroxide, FePO₄, Fe₂(PO₄)₃, ferrous ammonium phosphate, ferric pyrophosphate, ferric nitrate, ferrous nitrate, ferrous sulfate, ferric sulfate, ferric chloride, ferrous chloride, iron carbonate, ferrous carbonate, ferrous oxalate, or a mixture of two or more thereof.

7. The method of claim 1, wherein the X source material is a phosphate source material.

8. The method of claim 7, wherein the phosphate source material is iron phosphate, H₃PO₄, P₂O₅, NH₄H₂PO₄, (NH₄)₂HPO₄, NH₄FePO₄, (NH₄)₃PO₄, Li₃PO₄, LiH₂PO₄, FePO₄, Fe₃(PO₄)₂, or a mixture of two or more thereof.

9. The method of claim 1, wherein the M source material is a vanadium source material.

10. The method of claim 9, wherein the vanadium source material is V₂O₅, V₂O₃, NH₄VO₃, or a mixture of two or more thereof.

11. (canceled)

12. (canceled)

13. The method of claim 11, wherein the carbon source is selected from Saccharose, fructose, propanedioic acid, adipic acid, acrylic acid, salicylic acid, lauric acid, ascorbic acid, Oleic acid, isocaproatic acid, citric acid, or a mixture or two or more thereof.

14. The method of claim 1, wherein the carbon source is a polymeric carbon-containing material selected from polyethylene glycol (PEG), polyvinyl alcohol (PVA), polyvinyl butyral (PVB), Polypropylene, polyethylene, poly-pyrrolidone (PUP), polyacrylic acid (PAA), polypyrrole (PPY), or a mixture of two or more thereof.

15. (canceled)

16. (canceled)

17. The method of claim 1, wherein the organic solvent is selected from ethanol, acetone, ethylene glycol, isopropanol, DMF, Acetonitrile, or a mixture of two or more thereof.

18. (canceled)

19. The method of claim 1, wherein the molar ratio of the lithium source material:the metal source material:the phosphate source material is about 0.9-1.2:about 0.6-1.2:about 0.9-1.2.

20. The method of claim 1, wherein the weight ratio of the carbon source material:the metal source material is from 0 to about 45 g per molar.

21. The method of claim 1, comprising heating the mixture of source materials to a temperature between about 60° C. for about 1 hour to obtain a reaction mixture.

22. The method of claim 1, comprising stirring the reaction mixture at room temperature for about 15 hours to obtain a precursor material.

23. The method of claim 1, comprising heating the dried mixture in an inert atmosphere, first at 350° C. for about 3 hours and then at about 600° C. for about 6 hours.

24. The method of claim 1, wherein the nano-scale powdery precursor material has a particle size distribution of about 25 nm to about 500 nm.

25. A nano-scale powdery precursor material useful as an electrochemically active material, prepared by the process comprising:
mixing thoroughly a lithium source material, a metal source material for M, a source material for XO₄, in pre-determined molar ratios, in the present or the absent of a carbon source material, in pre-determined molar ratios in an organic solvent to obtain an amorphous mixture;
heating the amorphous mixture of source materials to a temperature between about 50° C. to less than or equal to the solvent boiling point at atmospheric pressure for about 0.5 to about 2 hours to obtain a reaction mixture;
stirring the reaction mixture in at room temperature for about 5 to about 20 hours to obtain a precursor material;
separating the powdery precursor from the solvent; and
drying by heating the powdery precursor at a temperature between about 50° C. to about 70° C. for about 2 to about 10 hours to obtaining a nano-scale powdery precursor material;
wherein M comprises at least one metal capable of undergoing oxidation to a higher valence state; wherein X is selected from the group consisting of P, Sb, V. S. Si, Al, Ge, As, and a mixture of two of more thereof; and
wherein the nano-scale powdery precursor material has the formula of LiₐM_{b}XO₄, wherein sand b are positive integer or fraction of an integer and ranges from about 0.001 to about 3.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A precursor to a lithium iron phosphate material cathode active material, prepared by the process comprising:
mixing thoroughly a lithium source material, an iron phosphate source material, and a carbon source material in pre-determined molar ratios in an organic solvent to obtain a mixture of source materials;
heating the amorphous mixture of source materials to a temperature between about 50° C. to less than or equal to the solvent boiling point at atmospheric pressure for about 0.5 to about 2 hours to obtain a reaction mixture:
stirring the reaction mixture at room temperature for about 5 to about 20 hours to obtain a precursor material;
separating the powdery precursor from the solvent; and
drying by heating the powdery precursor at a temperature between about 50° C. to about 70° C. for about 2 to about 10 hours to obtaining a nano-scale powdery precursor material.

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)
